(19) United States
(12) Patent Application Publication
(10) Pub. No.: US 2008/0034599 A1
(43) Pub. Date: Feb. 14, 2008

(54) Modular Multipurpose Carpenter's Tool

(76) Inventor: George Gatewood Hamilton, Georgetown, KY (US)

Correspondence Address: JAMES M. FRANCIS, 300 W VINE ST, STOLL KEENON OGDEN PLLC, LEXINGTON, KY, 40507, US

(21) Appl. No.: 11/164,531

(22) Filed: Nov. 28, 2005

(51) Int. Cl. B43L 7/10

(52) U.S. Cl. 33/471

(57) ABSTRACT

An apparatus for use as a framing square, protractor, and level that assists a user in laying out walls, checking existing walls for square, level and plumb, assists in hanging cabinets and installing built-ins on true walls and floors, scribe odd angled walls for erection, eliminates corner laps when doing floor layout, and is compact enough to fit into an easily stored and transported carrying case. The apparatus can be used by the skilled tradesman in calculating both the tread and the rise of stairs and will tell him how long to cut the stringer on uneven ground.

### RELATED U.S. APPLICATION DATA

Not applicable.

### BACKGROUND OF THE INVENTION

1. Field of the Invention

The present invention relates, in general, to a carpenter's framing square, more specifically, to apparatus for use as an extendable framing square, protractor, and level that is capable of being quickly assembled and disassembled and which provides for easy storage and transportation.

2. Problems in the Art

Carpenters frequently use framing squares, protractors and levels as a means of working more efficiently and accurately. To insure proper perpendicularity and angularity such that adjacent members are correctly aligned, framing squares and levels and gages are commonly employed. Most widely used is a carpenters framing square. The typical framing square is a single L-shaped piece of material having unequal legs having indicia at periodic markings to indicate incremental lengths. Levels may be integrated with such tools. While seeking to provide gage markings for additional carpentry tasks, angular indicia, compound cut markings and the like have been included in multi-purpose framing tools, this multiplicity of information is oftentimes confusing, unneeded or inherently provided by the construction tools.

One such approach is disclosed in U.S. Pat. No. 4,506,451 to Hiltz wherein an adjustable mechanical stop is provided to set an associated straight edge at a desired marking inclination. Liquid levels are incorporated for use in aligning 90 degree and 45 degree cuts. Discrete stops are required for each inclination. U.S. Pat. Nos. 4,745,689 to Hiltz, 4,922,621 to Maier, D197,309 to Schimmelman and D220,061 to Kerns disclose foldable selectively pivotal arm and straight edge-level tools that can be preset to replicate angular cuts. U.S. Pat. No. 5,669,149 to Meitzler and U.S. Pat. No. 4,394,801 to Thibodeaux disclose another foldable arm tools containing indicia, angular and numeric for establishing varying pitches and cut angles.

Hitchcock, in U.S. Pat. No. 6,839,974 titled “Multi-function layout square with laser”, describes a multi-function layout square of modular construction having a laser that is capable of performing multiple functions is disclosed. The multi-function square has a metallic outer casing with magnetic properties, with a protractor plate slidably, pivotally, and removably attached by thumbscrews to the casing that can be moved and rotated with respect to the casing and slid linearly along a portion of the length of the casing. When the protractor plate is removed the casing may be used as a level, a plumb bob, a ruler, and a compass. When the protractor plate is attached the tool may be used as a framing square, roofing framing square or rafter square, and a gauge or scribe for straight lines, arcs, or circles.

Hochman, U.S. Pat. No. 2,054,420 discloses a combination drafting implement comprising a flat protractor with a flat scale superposed thereover and pivotally connected thereto for rotational movement relative to one another. The scale has a series of small apertures for receiving the sharp point of a pencil.

Terenzoni, U.S. Pat. No. 5,446,969 discloses a combination square and multi-purpose hand tool having an L-shaped body with a blade portion and a handle portion fixed perpendicular to the blade portion. A plate having an arcuate slot is pivotally attached in an elongate slot in the blade portion and extends from an outermost position parallel to the handle portion to an inner position folded against the blade portion. The plate moves with respect to the perpendicular leg (handle) of the L-shaped body to function as a clamp or as a caliper. Bubble levels are mounted in the pivotal plate. There is no laser beam light source, nor would it be possible for Terenzoni to be used as a plumb bob.

Webb, U.S. Pat. No. 5,519,942 discloses a device for performing leveling and transit functions having an elongated member with parallel spaced-apart top and bottom flat surfaces separated by a thickened web that includes several cutouts exposing bubble indicators arranged in a variety of orientations and includes a rotary module at one end movably mounting a laser beam generator. The rotary module has a passageway conducting a laser beam to a selected one of several slots or passageways provided in the end of the member. The web includes a housing adjacent to the rotary module enclosing electrical circuits, battery power supply and button controls for operation of the laser. A pivoting panel is coextensive with the top flat surface in a stored position while pivotal to a position normal to the top flat surface when used as a corner square. A thumb adjustment screw protrudes from the web through a flat surface to angle the device if desired.

Rushing, U.S. Pat. No. 6,742,271 titled “Retractable straightedge framing square integrable to a level” describes a masonry tool that is a framing square with a retractable straightedge, where the framing square can be fitted to a level. The major components of the invention are a foldable flat straightedge, a mounting bar and housing which seats a notched disk that rotates on an axial shaft that is joined to the straightedge, a finger activated switch that moves a spring loaded slideable pin that clicks into a notch on the disk corresponding to an angle, and fastening components and elements for longitudinally affixing the mounting bar and housing to the end of the level. The retractable straightedge, when unlocked, can be rotated from a retracted position to a reversibly locked right angle position, and vice versa.

The present invention is distinguished over the prior art in general, and these patents in particular by its lightweight construction, easy assembly and disassembly, ability to customize the length by adding as many sections as necessary, absence of small part to lose, and compact arrangement when disassembled.

### SUMMARY OF THE INVENTION

The invention is a carpentry tool useful for confirming that carpentry work is square, level and plumb. The invention is an integrable framing square with an rotatable joint that acts as a protractor and also contains multiple level indicators such as bubble levels. The articulatable elements of the invention are the positionable arms that can be locked, except when rotating to a new position and the extension sections or lengthening sections which may be joined onto the ends of the arms by means of a catch mechanism preferably located on the end of the extension that is to be joined to the arm.

A means for measuring the angle between the arms is incorporated into the joint. The means is preferably a scale integrated into the joint that indicates the precise angle but it could easily be an electronic measurement or similar means known to those skilled in the art. The two arms may be rapidly disassembled by unscrewing the threaded knob from the assembly. The two arms pivot about the post protruding from the knob. The knob may also utilize one of many catch mechanisms known to those skilled in the art, which could be decoupled from the arms and subsequently removed therefrom allowing the arms to be detached from one another for easy storage and transportation.

The arms and extensions possess tick marks to allow measurement in English units or Metric units or both from the joined and/or terminal end of each arm of the framing square. Alternatively, the arms and extensions possess means, known to those skilled in the art, for marking the measured points to eliminate the urgency in writing down the measurement before the user has a chance to forget the measured value.

The apparatus is advantageous in that the catch mechanism allows the user to simply slide extensions onto the end of an arm which are then locked into position by the mechanism. The lack of screws, bolts, pins, or similar fastening mechanism is an advantage in that there are no small parts to lose and assembly is rapid and requires only one free hand to hold the extension and slide it into the catch mechanism. Ideally the arms and extensions are constructed or extruded into the shape and geometry of a traditional I-beam. Most preferred is extruded aluminum because of its strength, cost, and that it is lightweight. Alternatively the aluminum could be anodized for aesthetics. Additional embodiments would utilize plastics and carbon. The I-beam is preferred in that it supplies sufficient rigidity while reducing the weight of the device compared to solid block construction or simple planar construction. The I-beam is anticipated to have traditional cutouts from the mid-panel or face that serve to reduce the weight of the device while not impacting strength and rigidity.

The catch mechanism receives the mid-panel or face of the I-beam of the arm onto which the extension is to be attached, and which possess a catch mechanism slot to receive the catch of the catch mechanism. A catch mechanism release permits rapid disassembly of the assembled device. The preferred catch mechanism comprises the catch plate and a support plate. The catch plate possesses a catch spring, most preferably a thin metal strip that can be easily raised to release the catch but which is sufficiently loaded so as to securely hold the catch in its engaged position through the catch plate catch slot and the extension catch slot.

The catch itself is beveled at its leading edge so that it slides into a release position as extensions are inserted into the catch mechanism. The trailing edge of the catch is not beveled so that, once the extension is attached, it will not easily disengage from the catch slot of the extension. The catch is somewhat loosely fastened to the spring by the catch screws so as to allow some movement of the catch to facilitate disengagement of the catch from the catch slot of the arm. The catch plate preferably possesses a cutout at the end of the catch spring so that it can easily be disengaged by lifting the catch spring with a finger or screwdriver or similar implement that is inserted beneath the catch spring.

An alternative embodiment would allow for the incorporation of laser sights into the arms and extensions so that alignment with the device arms may be accomplished without adding extensions. An additional embodiment would permit the attachment of magnetic plates for holding screws, nails, and the like.

### BRIEF DESCRIPTION OF THE DRAWINGS

The foregoing and other objects will become more readily apparent by referring to the following detailed description and the appended drawings in which:

FIG. 1 is a perspective view of an integral framing square with levels having two arms which are articulatable about their conjoined ends.

FIG. 2 is a side view of the invention illustrating the articulatable framing square with levels and integrated protractor.

FIG. 3 is a perspective view of the catch mechanism as attached to an I-beam of an extension.

FIG. 4 is an exploded view of the catch mechanism depicting the spring and attached catch, the catch plate and the support plate.

FIG. 5 is a side view of the spring and catch.

### DETAILED DESCRIPTION OF THE DRAWINGS

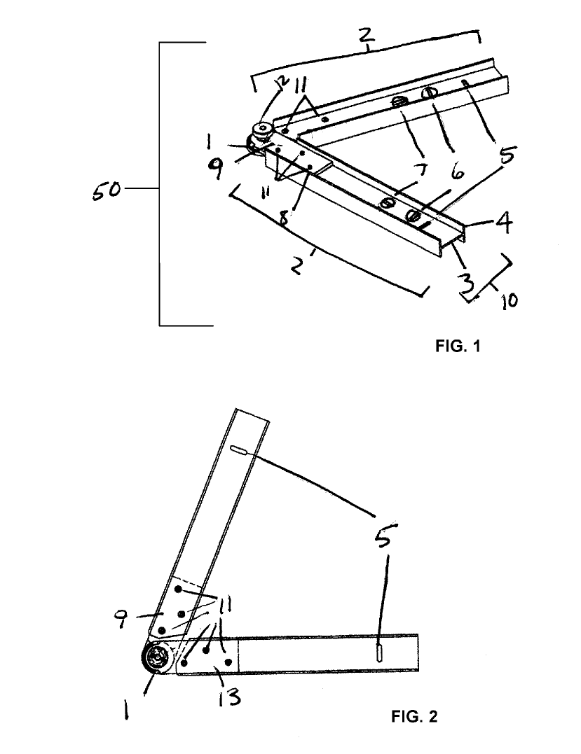

FIG. 1 depicts a perspective view of the device 50 from the side opposite of the protractor 1. Depicted are the arms 2 of the framing square 50 that articulate about the threaded fastening knob 12 that joins the two arms 2. The catch slots 5 that receive the catch 20 are also shown. The inferior protractor plate 9 is depicted as being fastened to an arm 2 by pop rivets 11. The pop rivets connecting the superior protractor plate 13 to an arm 2 can be viewed on the opposing arm 2. Parallel levels 7 and perpendicular levels 6 can be seen on the face 3 or mid-panel 3 of the I-beam 10. Markings 8 for measurement of distance are present on the I-beam wings 4.

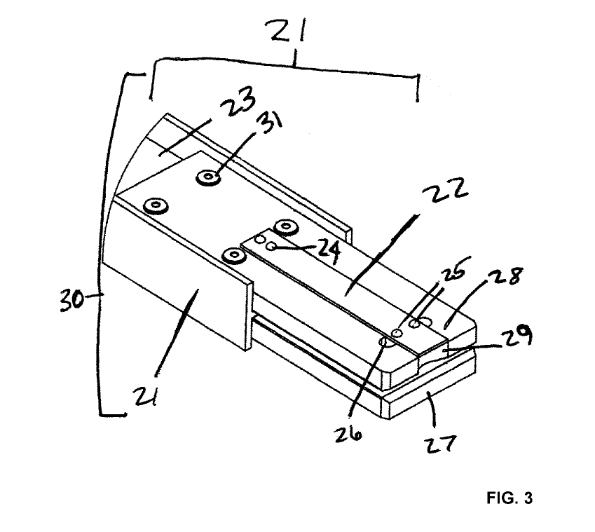

FIG. 2 depicts a side view of the device 50 from the protractor side. Depicted are the catch slots 5 on the face of the I-beam 10, the protractor gauge 1, the superior protractor plate 13, and the pop rivets 11 connecting the superior and inferior protractor plates, 13 and 9 respectively, to the arms 2.

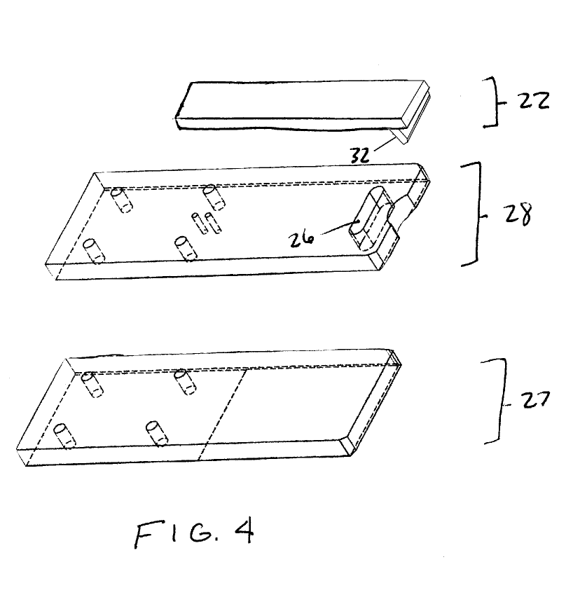

FIG. 3 is a perspective view of the catch mechanism 30 as attached by catch plate pop rivets 31 to the face 23 of an extension I-beam 21. Shown are the spring plate 22, spring plate fasteners 24, catch fasteners 25, catch plate slot 26, catch support plate 27, catch plate 28, and catch release finger groove 29.

FIG. 4 is an exploded view of the catch mechanism. Shown are the catch plate 28, the catch support plate 27, the spring plate 22, and the catch 32. The spring plate 22 is shown to be fastened to the top of the catch plate 28 by catch plate pop rivets 31. The catch 32 is attached to the bottom of the spring plate 22 so that it is positioned to pass through the catch plate slot 26 and engage the arm catch slot 5. The catch fasteners 25 are tightened so as to allow some movement of the catch 32 itself. This facilitates disengagement of the catch 32 from the arm. The catch plate 28 and catch support plate 27 are depicted with the rivet holes 33 at the end opposite the catch 32. The catch plate 28 is depicted as possessing spring plate rivet holes 34 and a catch slot 26 through which the catch 32 passes.

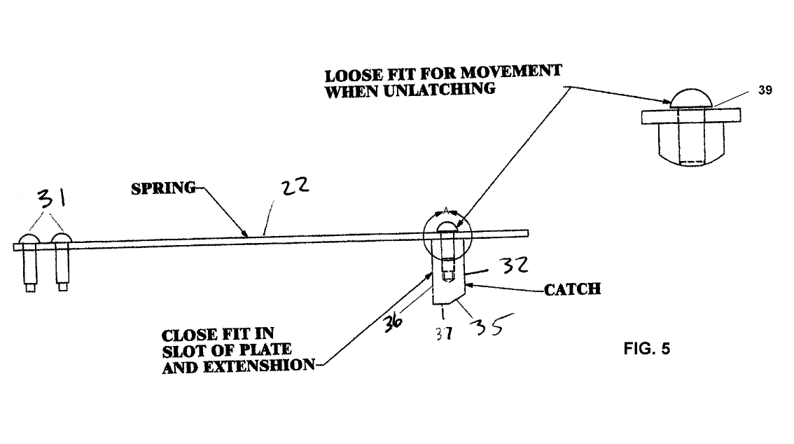

FIG. 5 depicts a side view of the spring plate 22. Shown are the spring plate 22, catch plate pop rivets 31 for fastening the spring plate 22 to the catch plate 28, one of two catch fasteners 25 that fasten the catch 32 itself to the spring plate 22, and the catch 32. The catch 32 is shown to possess a beveled forward edge 35 to facilitate disengagement of the catch 32 from its rest position when it engages the I-beam 10 or 21 of an arm 2 or extension. The trailing edge 36 of the catch 32 is shown to not be beveled, but in fact be flat and terminating at a right angle with the catch bottom 37 so as to secure the catch 22 in the catch plate catch slot 26 and the arm or extension catch slot 5.

What is claimed is:

1. An apparatus comprising at least two arms substantially perpendicular to each other having first and second ends; said arms rotatably joined at one end in substantially a right angle; said rotatable joint possessing means for measuring the angle between said arms; attachable extensions for said arms; and a means for attaching said extensions to said arms.

2. The apparatus of claim 1, each said arm possessing means for measuring the distance of a point along the length of said arm from said first end.

3. The apparatus of claim 2, each said arm further possessing means for measuring the distance of a point along the length of said arm from said second end.

4. The apparatus of claim 1, the means for measuring the angle between said arms being a protractor.

5. The apparatus of claim 4, said protractor being comprised of the group consisting of manual protractors and electronic protractors.

6. The apparatus of claim 1, said arms being detachably joined at said rotatable joint.

7. The apparatus of claim 1, said arms possessing means for measuring the vertical position of said first end of one said arm relative to the vertical position of said second end.

8. The apparatus of claim 7, said means for measuring the vertical position of said first end of one said arm relative to the vertical position of said second end being a level bubble.

9. The apparatus of claim 1, wherein at least one said arm possesses at least one laser sight.

10. The apparatus of claim 1, wherein said second end possesses a laser sight.

11. The apparatus of claim 1, wherein said extensions possess said means for attachably receiving said extensions.

12. The device of claim 1, wherein said arms and said extensions are comprised of a rigid, lightweight material.

13. The apparatus of claim 12, wherein said arms and said extensions are comprised of extruded aluminum.

14. The apparatus of claim 13, wherein said arms and said extensions are fashioned in an I-beam geometry.

15. The apparatus of claim 14, wherein said extensions are coded as to order of assembly.

16. The apparatus of claim 14, wherein said means for attachably receiving is a catch mechanism.

17. The apparatus of claim 16, wherein said catch mechanism mates a catch with the face of said I-beam on said extension.

18. The apparatus of claim 17, wherein said catch is beveled.

19. The apparatus of claim 17, wherein said catch engages a catch slot on the arm of the apparatus.

20. The apparatus of claim 17, wherein said catch mechanism further comprises a catch plate, a catch support plate, and a spring plate.

21. The apparatus of claim 20, wherein said catch plate has a means to rapidly disengage said catch.

22. The apparatus of claim 1, wherein said means for attachably receiving is a clamping mechanism.

23. An apparatus comprising at least two arms substantially perpendicular to each other, each having first and second ends, each said arm possessing means for measuring the distance of a point along the length of said arm from said first and second ends; said arms rotatably and detachably joined at one end in substantially a right angle; said rotatable joint possessing means for measuring the angle between said arms; attachable extensions for said arms; a means for attaching said extensions to said arms; and said arms possessing level bubbles.

24. The method of extending the arm of a framing square made of I-beam construction by sliding a catch mechanism integrated into an extension onto the face of said I-beam to engage a catch slot in the face of said arm.
